(19) United States
(12) Patent Application Publication
(10) Pub. No.: US 2015/0325890 A1
(43) Pub. Date: Nov. 12, 2015

(54) SYSTEM FOR UNIFORMLY DISTRIBUTING TEMPERATURE ACROSS BATTERIES

(71) Applicant: Go-Tech Energy Co., Ltd., New Taipei City (TW)

(72) Inventors: Tzu-Wen SOONG, Taipei (TW); Li-Zen LAI, Taipei (TW)

(73) Assignee: Go-Tech Energy Co., Ltd., New Taipei City (TW)

(21) Appl. No.: 14/274,047

(22) Filed: May 9, 2014

(51) Int. Cl. H01M 10/617; H01M 2/12

(52) U.S. Cl. CPC H01M 10/617; H01M 2/1264; H01M 10/6566; H01M 10/6568

(57) ABSTRACT

A system for uniformly distributing temperature across battery units is disclosed. The system includes: a heat conducting fluid, enclosing the battery units and being capable of substantially circulating around the battery units and/or along a specified path among the battery units; a closed housing, enclosing the battery units and the heat conducting fluid; and a circulating module, installed inside or out of the closed housing, for driving the heat conducting fluid to circulate around the battery units and/or along the specified path. When the circulating module drives the heat conducting fluid to circulate, temperature across the battery units is substantially uniformly distributed.

### FIELD OF THE INVENTION

The present invention relates to a system for uniformly distributing temperature. More particularly, the present invention relates to a system for uniformly distributing temperature across batteries.

### BACKGROUND OF THE INVENTION

Rechargeable battery packs are widely used in many fields. From personal computers to electric vehicles, most products related to daily life are driven by rechargeable battery packs. Newly developed rechargeable battery packs are environmental protective, long working life and having stable quality. It makes people have a better life with less carbon dioxide and air pollution.

However, there are still some defects that rechargeable battery packs need to be improved. One of them is aging due to unbalance between rechargeable battery cells. A rechargeable battery pack is composed of many rechargeable battery cells depending on its capacity. The rechargeable battery cells are linked to each other in series or parallel. They are also the key part of the rechargeable battery pack. The rechargeable battery cells will become hot when they are charging or discharging. When temperature of a rechargeable battery cell is too high, its life cycle will reduce. Hence, how to prevent the rechargeable battery cells getting heated has been studied for a long time and achieves very good results, especially for rechargeable battery packs with large power capacity. On the other hand, there is still a trouble: non-uniform distribution of temperature across the rechargeable battery cells. It is the well-known factor causes unbalance of rechargeable battery cells. A hotter rechargeable battery cell than others will get aging faster. Therefore, its electric properties, such as power capacity, will become different than others. Since the rechargeable battery pack works with all rechargeable battery cells healthily functions, when one or some rechargeable battery cells can not do their job well due to the unbalance problem, the rechargeable battery pack may fail or performance get worse to use.

Hence, there are many prior arts providing different temperature controlling means to settle the problem mentioned above. One of them is disclosed in the U.S. Pat. No. 8,426,050. Please refer to FIG. 1. A temperature control system 10 for cooling a rechargeable battery module 6 is illustrated. The system 10 includes a reservoir 2, a pump 4, and conduits 7, 8 and 9. The reservoir 2 holds a fluid inside. The pump 4 pumps the fluid from the reservoir 2 via the conduit 7. Thereafter, the pump 4 pumps the fluid into the rechargeable battery module 6 via the conduit 8. The rechargeable battery module 6 includes a cooling manifold 1, heat exchangers 5, and a cooling manifold 3 that will be explained in greater detail below. The cooling manifold 1 is configured to provide a substantially equal flow rate of the fluid through each of the respective heat exchangers 5 in the rechargeable battery module 6 such that the rechargeable battery cells inside have a substantially equal amount of heat energy removed from the rechargeable battery cells. Thus, all of the rechargeable battery cells in the rechargeable battery module 6 are maintained at a substantially similar temperature resulting in the rechargeable battery cells having uniform operational characteristics including output voltages. The cooling manifold 3 receives the heated fluid from the heat exchangers 5 in the rechargeable battery module 6 and routes the heated fluid through the conduit 9 back to the reservoir 2.

'050 is a typical invention providing architecture that cools down the temperature of the internal rechargeable battery cells with help from some other detailed parts. However, there is a problem. It is obvious that the temperature of the fluid in the conduit 8 is cooler than that in the conduit 9 since the back flow of the fluid from the conduit 9 is cooled down by the external environment. But for the rechargeable battery cells, the closer to the conduit 8 side it is located, the better cooling effect (temperature drop) it can be. This is because the fluid carries heat from one rechargeable battery cell contacted first to others contacted later. The later can not dissipate more heat than the former while both of them work under similar situation and generate almost the same heat. In addition, the cooling manifold 1 and 3 and the heat exchangers 5 are complicated devices. Complexity makes the system 10 a higher cost. Most of all, the system 10 can only cools down the rechargeable battery cells but fails to warm them up. For rechargeable battery packs work in chilling area, a proper heater to offer heat to the rechargeable battery cells is useful to operate longer for the rechargeable battery packs.

Hence, a system with simple structure and low constructing cost to implement both controlling and uniformly distributing temperature across battery units is desired.

### SUMMARY OF THE INVENTION

Current temperature control systems for rechargeable battery cells or even rechargeable battery packs have some defects: temperature distribution is not uniform, cost is high. Therefore, a system with simple structure and low constructing cost to implement both controlling and uniformly distributing temperature across battery units is desired.

According to one aspect of the present invention, a system for uniformly distributing temperature across battery units includes: a heat conducting fluid, enclosing the battery units and being capable of substantially circulating around the battery units and/or along a specified path among the battery units; a closed housing, enclosing the battery units and the heat conducting fluid; and a circulating module, installed inside or out of the closed housing, for driving the heat conducting fluid to circulate around the battery units and/or along the specified path. Each battery unit linked to each other in series or in parallel. When the circulating module drives the heat conducting fluid to circulate, temperature across the battery units is substantially uniformly distributed.

Preferably, the battery unit is a rechargeable battery cell or a rechargeable battery pack. The heat conducting fluid is a heat conducting gas or a heat conducting liquid. The heat conducting gas is air or inert gas. The heat conducting liquid is water, silicon oil or liquid containing magnetic materials.

The system further includes a circulating conduct, arranged among the battery units, for providing the specified path for the heat conducting fluid.

Preferably, the circulating module is a pump, a vibrator, a fan, a motor with a magnetic rotor or a device having a magnetic rotor driven by change of magnetic forces out of the closed housing.

According to another aspect of the present invention, a system for uniformly distributing temperature across battery units includes: a heat conducting fluid, enclosing the battery units and being capable of substantially circulating around the battery units and/or along a specified path across the battery units; a housing, accommodating the battery units and partially the heat conducting fluid, and having at least one ventilating hole where a portion of the heat conducting gas can move out of or into the housing; and a circulating module, installed inside the housing, for driving the heat conducting fluid to circulate around the battery units and/or along the specified path; and a circulating module, installed inside or out of the housing, for driving the heat conducting fluid to circulate around the battery units and/or along the specified path. Each battery unit is linked to each other in series or in parallel. When the circulating module drives the heat conducting fluid to circulate, temperature across the battery units is substantially uniformly distributed.

Preferably, the heat conducting fluid is a heat conducting gas or a heat conducting liquid. The heat conducting gas is air or inert gas. The heat conducting liquid is water, silicon oil or liquid containing magnetic materials. The battery unit is a rechargeable battery cell or a rechargeable battery pack. The circulating module is a vibrator, a fan, a motor with a magnetic rotor or a device having a magnetic rotor driven by change of magnetic forces out of the housing. The amount of the heat conducting fluid moved out of or into the housing during circulating is smaller than an exchange amount of the whole heat conducting fluid in the housing before circulation begins. The exchange amount is 30% of the whole heat conducting fluid or less in the housing.

With the circulation of heat conducting fluid, temperature can be uniformly distributed across battery units. Meanwhile, the system according to the present invention has low constructing cost. The uniformly distributed temperature can be further adjusted by other means out of the system.

### BRIEF DESCRIPTION OF THE DRAWINGS

FIG. 1 shows a prior art of a cooling system.

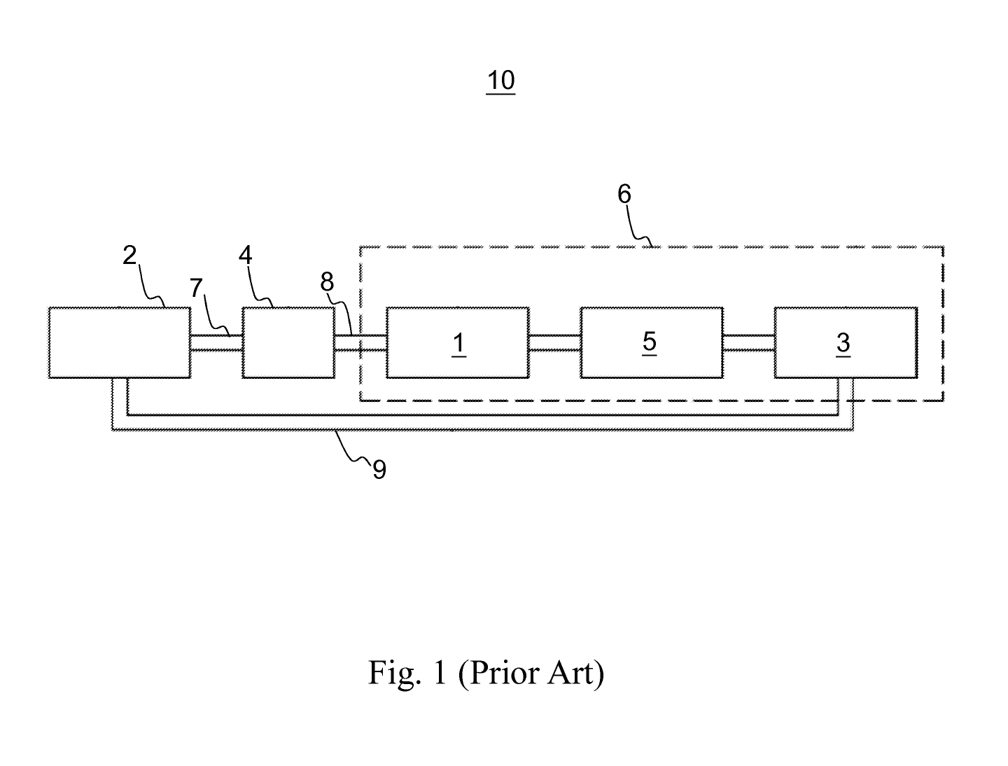

FIG. 2 illustrates an embodiment according to the present invention.

FIG. 3 illustrates another embodiment according to the present invention.

FIG. 4 illustrates still another embodiment according to the present invention.

FIG. 5 shows temperature distribution of rechargeable battery cells in a rechargeable battery pack under different systems.

FIG. 6 illustrates still another embodiment according to the present invention.

### DETAILED DESCRIPTION OF THE PREFERRED EMBODIMENTS

The present invention will now be described more specifically with reference to the following embodiments.

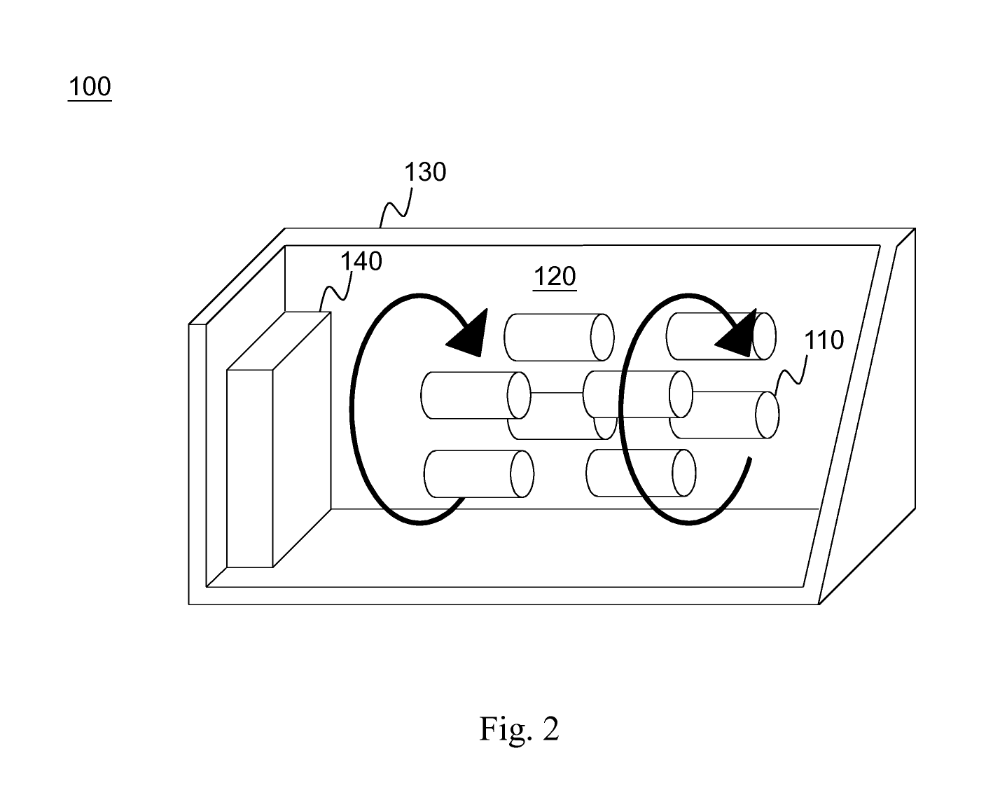

Please refer to FIG. 2. An embodiment of the present invention is disclosed. A system 100 is used to uniformly distribute temperature across rechargeable battery cells 110. For illustration purpose, there are eight rechargeable battery cells 110.

The system 100 includes a heat conducting fluid 120, a closed housing 130 and a pump 140. Please notice that FIG. 2 is just for illustration so that some portion of the closed housing 130 is removed. Parts inside the closed housing 130 can be seen. In fact, the closed housing 130 is well-formed so that it can keep the heat conducting fluid 120 inside without overflow or seepage. Besides, the rechargeable battery cells 110 are each linked to each other in series or in parallel. The number of the rechargeable battery cells 110 is not limited to eight. It can be any number as they are further used for a rechargeable battery pack with a designed capacity. The system 100 provided by the present invention can be applied to any combination of rechargeable battery cells 110. Hence, any detailed linkage between each rechargeable battery cell 110 and other auxiliary parts for fixing the rechargeable battery cells 110 and power conduction are possible but not described here. Only the system 100 itself and operating method are shown.

The heat conducting fluid 120 used here is silicon oil. Actually, the heat conducting fluid 120 can be other heat conducting gas or heat conducting liquid. For example, if a heat conducting gas is used, it can be air, one inert gas or a mixture of inert gases, or even a combination of air and inert gas, depending on the cooling effect that the system 100 would like to achieve and its cost. If a heat conducting liquid is adopted, the heat conducting fluid 120 can be silicon oil. A very special condition that liquid containing magnetic materials can be used. It will be illustrated later. The heat conducting fluid 120 encloses the rechargeable battery cells 110 without causing any physical or chemical damage. The heat conducting fluid 120 is capable of substantially circulating around the rechargeable battery cells 110. As shown in FIG. 2, the heat conducting fluid 120 can be driven to rotate around outside of the rechargeable battery cells 110. Since there are only eight rechargeable battery cells 110, the circulation passes all rechargeable battery cells 110 and uniformly takes away the heat they generate when working. Therefore, temperature across the rechargeable battery cells 110 is substantially uniformly distributed.

The closed housing 130 encloses the rechargeable battery cells 110 and the heat conducting fluid 120 inside. If the system 100 and the heat conducting fluid 120 are used as a rechargeable battery pack, the closed housing 130 can be the case of the rechargeable battery pack. Materials of the closed housing 130 can be metal, plastic, glass fiber or other suitable stuffs.

The pump 140 is the key part to operate the system 100. It is installed inside the closed housing 130. When it functions, the heat conducting fluid 120 is driven to circulate around (as indicated by the arrows in FIG. 2) the rechargeable battery cells 110 or along a specified path across the rechargeable battery cells 110 so that uniformly distribution of temperature of the rechargeable battery cells 110 is achieved. The circulation can both pass through the specified path and move around the rechargeable battery cells 110. It is appreciated that any kind of pump can be used in the present invention. Since the heat conducting fluid 120 itself circulates all parts, e.g. fixtures, a conductive sheet, a BMS etc., connected to the rechargeable battery cells 110, the heat causing higher temperature than the average temperature from the parts will be taken away. Hence, temperature in the space which the heat conducting fluid 120 circulates is substantially uniformly distributed.

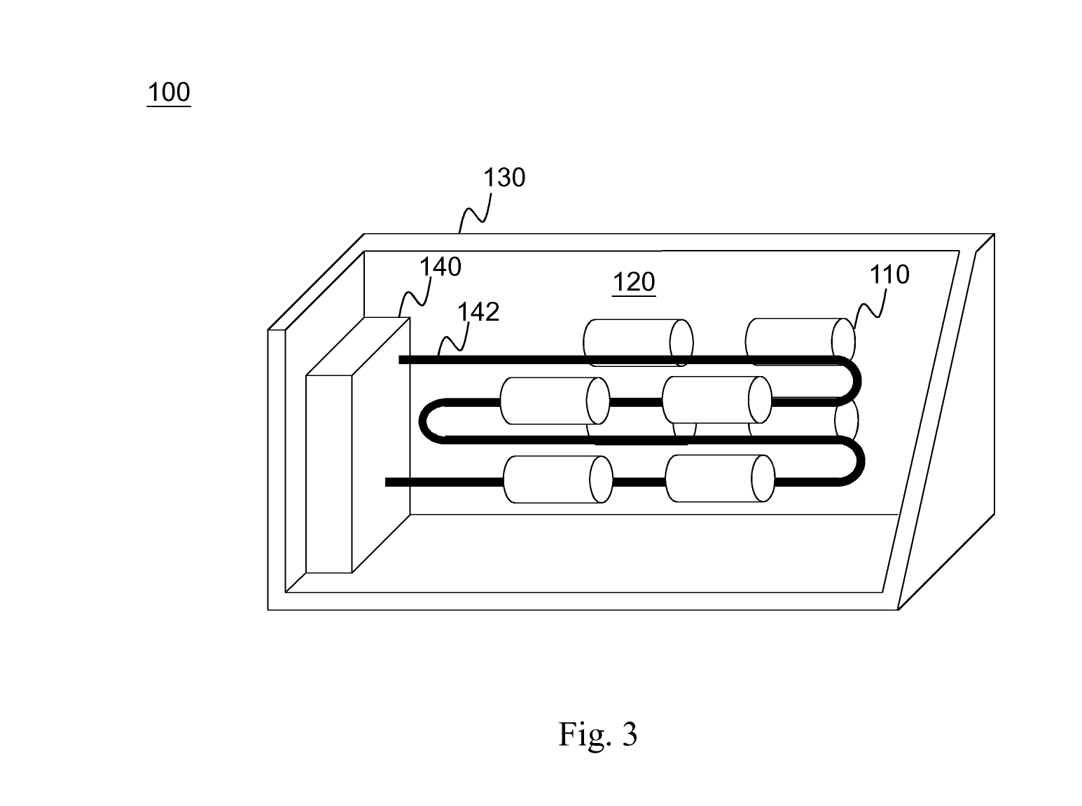

In another embodiment, the specified path can be physically implemented. Please refer to FIG. 3. For illustration, the architecture of the system 100 in the previous embodiment is used in the present embodiment. It is different that the pump 140 is further linked to a circulating conduct 142. The circulating conduct 142 is arranged among the rechargeable battery cells 110. In FIG. 3, it is formed as a meandering shape between the front four rechargeable battery cells 110 and the back four rechargeable battery cells 110. The circulating conduct 142 provides the specified path to the heat conducting fluid 120. When the heat conducting fluid 120 is driven by the pump 140 and circulates through the circulating conduct 142, it takes away the heat from the rechargeable battery cells 110. The pump 140 can also exchange the heat conducting fluid 120 inside the circulating conduct 142 with that out of the circulating conduct 142. Different from the prior art of '050, since the closed housing 130 forms a confined space, after several circulations, the temperature can be uniformly distributed across the rechargeable battery cells 110, even the whole space inside the closed housing 130 ideally.

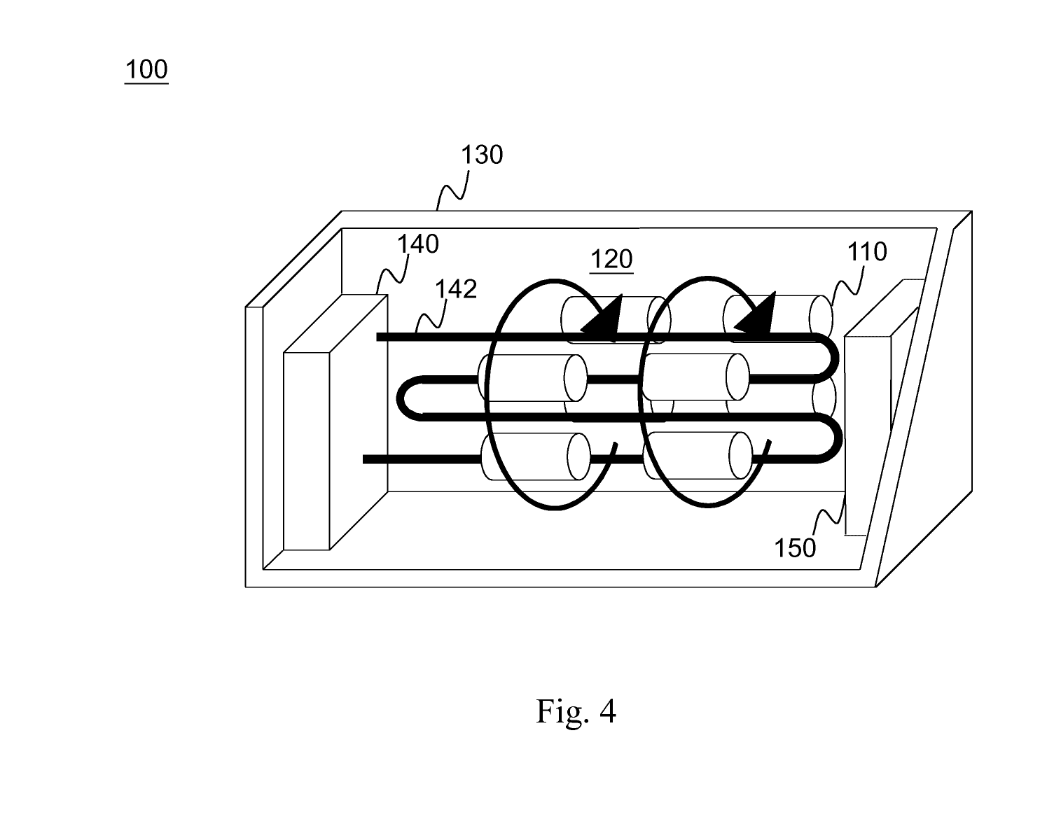

In still another embodiment, the heat conducting fluid 120 can both circulate around the rechargeable battery cells 110 and along the specified path across the rechargeable battery cells 110 to uniformly distribute the temperature across the rechargeable battery cells 110. That is, an auxiliary pump 150 is mounted based on the architecture in FIG. 4. The auxiliary pump 150 is used to drive the heat conducting fluid 120 to circulate around (as indicated by the arrows in FIG. 4) the rechargeable battery cells 110. The system can distribute the temperature with two flows. According to the present invention, there can be any number of pumps or circulating modules to make many flows for distribution of temperature. Another changed way is using some other material for the heat conducting fluid 120 in the circulating conduct 142, independent from the heat conducting fluid 120 out of the circulating conduct 142. The two materials circulate inside or out of the circulating conduct 142 respectively. For example, the heat conducting fluid 120 in the circulating conduct 142 is water and that outside of the circulating conduct 142 is silicon oil. It is still able to substantially uniformly distribute according to the present invention. In general, the pump 140 or 150 can be replaced by a vibrator. The vibrator still has a function to direct the flow of the heat conducting fluid 120. In other embodiment, the pump 140 or 150 is in a form of a motor with a magnetic rotor. The heat conducting fluid 120 must be a liquid containing magnetic materials. Thus, when the motor rotates the magnetic rotor, the magnetic materials in the liquid will move accordingly. As a result, the heat conducting fluid 120 (the liquid) circulates to distribute temperature uniformly. The motor with a magnetic rotor can further be a device having a magnetic rotor driven by change of magnetic forces out of the closed housing 130. In other words, the driving device is installed outside the closed housing 130.

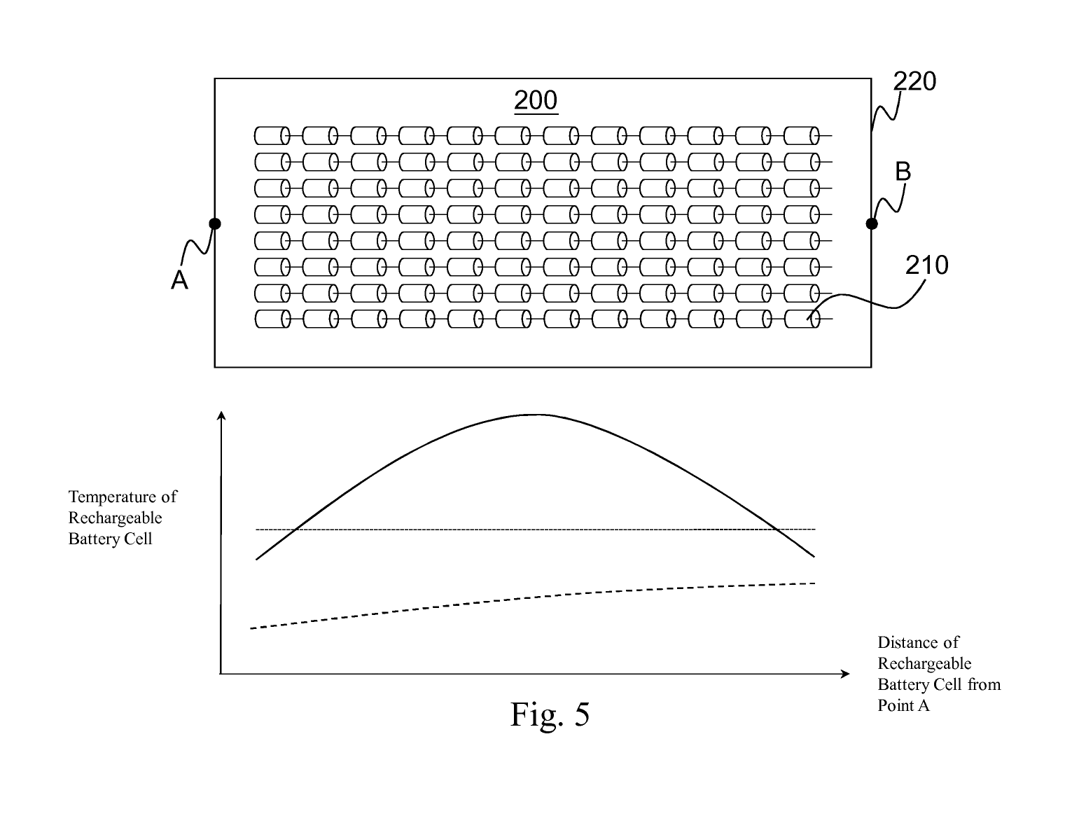

Please now refer to FIG. 5. Consider a rechargeable battery pack 200. It contains many rechargeable battery cells 210 inside a case 220. When the rechargeable battery pack 200 is not be cooled down during operation, temperature of each of the rechargeable battery cells 210 is distributed as a solid curve in a coordinate system below the sketch of the rechargeable battery pack 200. The horizontal axis shows a distance of one rechargeable battery cell 210 from point A in a cross-section of the rechargeable battery pack 200. It is obvious that the rechargeable battery cell 210 in the center of the rechargeable battery cells 210 has higher temperature than those in the peripherals. It is easily thought because it is harder to dissipate its heat by transmittance. When the cooling systems in prior arts are applied by circulating fluid through point A to point B to take away heat, the curve changes to a dashed one. It is found that the rechargeable battery cell 210 located closer to point A can be cooled down more than the one a little far from point A. The rechargeable battery cell 210 located most close to point B is the hottest one but still better than no circulation for heat dissipation is applied.

When the system provided by the present invention is applied, the temperature distribution curve becomes a horizontal line (as shown in the dot line in FIG. 5). It means all the rechargeable battery cells 210 get evenly cool-down. Although the temperature may be higher than the cooling systems in the prior arts are applied, the temperature in the rechargeable battery pack 200 can be further cooled down by another cooling means (not shown), e.g. a fan or a ventilated environment, out of the case 220. The temperature is still uniformly distributed for the rechargeable battery cells 210. In addition, the rechargeable battery cells 210 can be uniformly heated by another heating means (not shown) out of the case 220 for the rechargeable battery pack 200 works in a chilling area that a proper temperature is required to function well.

Of course, according to the spirit of the present invention, the treated target is not limited to the rechargeable battery cells; it can be the rechargeable battery packs. Namely, a group of rechargeable battery cells are cooled down at the same time. However, the key point is to maintain the uniformity of temperature across all rechargeable battery packs.

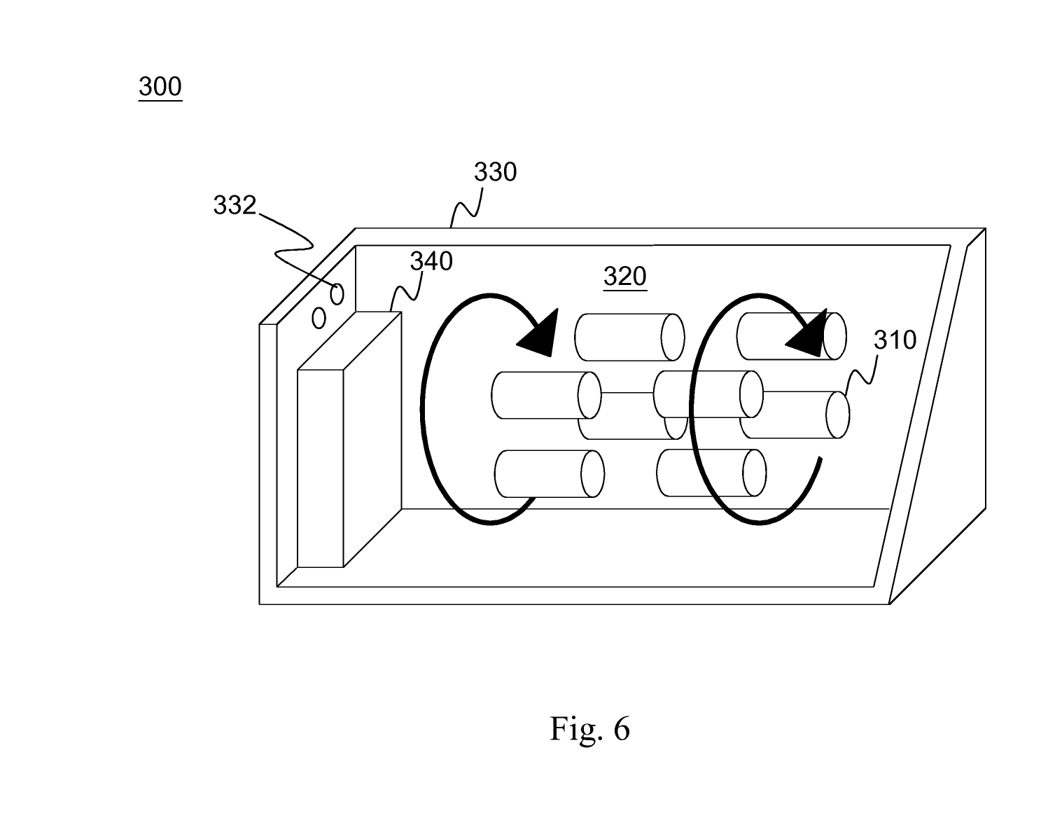

Please refer to FIG. 6. Another embodiment according to the present invention is disclosed. A system 300 is used for uniformly distributing temperature across battery units 310. Each battery unit 310 linked to each other in series or in parallel. As mentioned above, the battery units 310 can be rechargeable battery cells or rechargeable battery packs. The system 300 has a heat conducting fluid 320, a housing 330 and a fan 340.

The present embodiment is not restricted by a closed environment. Instead, partial heat conducting fluid 320 can move into and out of the housing 330. Therefore, the air is the best to be used as the heat conducting fluid 320. The heat conducting fluid 320 encloses the battery units 310 and is capable of substantially circulating around the battery units 310 and/or along a specified path across the battery units 310. There can be other internal path way guiders to lead the flow. It is not discussed here.

Accordingly, the housing 330 can only accommodates the battery units 310 rather than enclose them. The housing 330 can partially accommodate the heat conducting fluid 320 and have at least one ventilating hole 332. At the ventilating holes 332, a portion of the heat conducting fluid 320 can move out of or into the housing 330. Since the spirit of the present invention is to provide a substantially closed circulation for a uniform distribution of temperature across the battery units 310, the ventilating hole 332 is used to have slightly heat exchange with the external environment so that the system 300 can not only have uniform temperature distributed for all battery units 310 but also get temperature control slightly. If there are too many ventilating holes 332 or the area of the ventilating holes 332 is too large, internal status of temperature distribution will be broken. Preferably, the amount of the heat conducting fluid 320 moved out of or into the housing 330 during circulating is smaller than an exchange amount of the whole heat conducting fluid 320 in the housing 330 before circulation begins. The exchange amount may be 30% of the whole heat conducting fluid 320 or less in the housing 330. Due to the fluid boundary layer effect, an exchange amount greater than a certain percentage can be deemed that the heat conducting fluid 320 in the housing 330 starts to circulate out of the housing 330. It is not claimed by the present invention. Besides, the percentage is changeable to different design. In practice, 30% is for reference. A higher percentage of the exchange amount can fall on the scope of the present invention. It depends on if there is a fixed portion of the heat conducting fluid 320 remains to circulate inside the housing 330.

The fan 340 or the circulating module is installed inside the housing 330. It is used to drive the heat conducting fluid 320 to circulate around the battery units 310 and/or along the specified path. When the fan 340 drives the heat conducting fluid 320 to circulate, temperature across the battery units 310 is substantially uniformly distributed. As described in the several embodiments above, although the present embodiment is applied in the open housing 330, the heat conducting fluid 32 is not limited to air. It can be any heat conducting gas or heat conducting liquid. If it is a heat conducting gas, in addition to air, it can be an inert gas. The heat conducting liquid can be water, silicon oil or liquid containing magnetic materials. The fan 340 can be replaced by a vibrator, a motor with a magnetic rotor or a device having a magnetic rotor driven by change of magnetic forces out of the housing 330 according to different heat conducting fluids 320.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A system for uniformly distributing temperature across battery units, comprising:
a heat conducting fluid, enclosing the battery units and being capable of substantially circulating around the battery units and/or along a specified path among the battery units;
a closed housing, enclosing the battery units and the heat conducting fluid; and
a circulating module, installed inside or out of the closed housing, for driving the heat conducting fluid to circulate around the battery units and/or along the specified path,
wherein each battery unit linked to each other in series or in parallel; when the circulating module drives the heat conducting fluid to circulate, temperature across the battery units is substantially uniformly distributed.

2. The system according to claim 1, wherein the battery unit is a rechargeable battery cell or a rechargeable battery pack.

3. The system according to claim 1, wherein the heat conducting fluid is a heat conducting gas or a heat conducting liquid.

4. The system according to claim 3, wherein the heat conducting gas is air or inert gas.

5. The system according to claim 3, wherein the heat conducting liquid is water, silicon oil or liquid containing magnetic materials.

6. The system according to claim 1, further comprising:
a circulating conduct, arranged among the battery units, for providing the specified path for the heat conducting fluid.

7. The system according to claim 1, wherein the circulating module is a pump, a vibrator, a fan, a motor with a magnetic rotor or a device having a magnetic rotor driven by change of magnetic forces out of the closed housing.

8. A system for uniformly distributing temperature across battery units, comprising:
a heat conducting fluid, enclosing the battery units and being capable of substantially circulating around the battery units and/or along a specified path across the battery units;
a housing, accommodating the battery units and partially the heat conducting fluid, and having at least one ventilating hole where a portion of the heat conducting gas can move out of or into the housing; and
a circulating module, installed inside the housing, for driving the heat conducting fluid to circulate around the battery units and/or along the specified path; and
a circulating module, installed inside or out of the housing, for driving the heat conducting fluid to circulate around the battery units and/or along the specified path,
wherein each battery unit is linked to each other in series or in parallel; when the circulating module drives the heat conducting fluid to circulate, temperature across the battery units is substantially uniformly distributed.

9. The system according to claim 8, wherein the heat conducting fluid is a heat conducting gas or a heat conducting liquid.

10. The system according to claim 9, wherein the heat conducting gas is air or inert gas.

11. The system according to claim 9, wherein the heat conducting liquid is water, silicon oil or liquid containing magnetic materials.

12. The system according to claim 8, wherein the battery unit is a rechargeable battery cell or a rechargeable battery pack.

13. The system according to claim 8, wherein the circulating module is a vibrator, a fan, a motor with a magnetic rotor or a device having a magnetic rotor driven by change of magnetic forces out of the housing.

14. The system according to claim 8, wherein the amount of the heat conducting fluid moved out of or into the housing during circulating is smaller than an exchange amount of the whole heat conducting fluid in the housing before circulation begins.

15. The system according to claim 14, wherein the exchange amount is 30% of the whole heat conducting fluid or less in the housing.
